(19) United States
(12) Patent Application Publication
(10) Pub. No.: US 2024/0141925 A1
(43) Pub. Date: May 2, 2024

(54) Multi-Dimension Motor Mount Spacer/Adapter

(71) Applicant: SSW Advanced Technologies, LLC, Louisville, KY (US)

(72) Inventors: Jason Robert Yochum, Haubstadt, IN (US); Joshua Wiseman, Elizabethtown, KY (US)

(21) Appl. No.: 18/381,293

(22) Filed: Oct. 18, 2023

Related U.S. Application Data
(60) Provisional application No. 63/419,784, filed on Oct. 27, 2022.

(51) Int. Cl. F04D 29/64

(52) U.S. Cl. CPC F04D 29/646; F05D 2240/91

(57) ABSTRACT

A motor mount spacer/adapter arrangement includes a wire cage and at least one spacer. The wire cage includes one or more clamps having substantially equal inner dimensions. The at least one spacer/adapter is disposed adjacent the inner dimension of one of the clamps. As such, the one or more clamps is configured to secure an electric motor in the wire cage. In some versions, the electric motor can have a lower body portion of a first dimension and an upper body portion of a second dimension that is different than the first dimension. The at least one spacer/adapter is therefore configured to reside between one of the clamps and one of the upper and lower body portions of the electric motor.

### CROSS-REFERENCE TO RELATED APPLICATION

Priority is claimed to U.S. Provisional Patent Application No. 63/419,784, filed Oct. 27, 2022, the entire contents of which are hereby incorporated by reference herein.

### FIELD OF THE DISCLOSURE

The present disclosure is directed to a mount for a motor and, more particularly, a mount for an electric motor used in industrial applications.

### BACKGROUND

A variety of industrial applications including, for example, heating, ventilation, and air-conditioning (HVAC) units include electric motors for driving certain components. In HVAC units, electric motors are used to drive condenser fans. There are a variety of ways to mount these motors to ensure proper alignment of the motor output shaft with an input shaft of, for example, a condenser fan.

For example, in FIG. 1, an electric motor 10 is shown suspended within a conventional mount 11 including a metal cage 12 that itself is suspended from an upper panel 14 of an HVAC unit. The metal cage 12 includes four legs 16 coupled to and extending down from the upper panel 14. The legs 16 include various contours, bends, etc., and ultimately secure a pair of C-shaped clamps 18 that are shown in FIG. 1 clamped around a lower body portion of the electric motor 10. Each C-shaped clamp 18 includes a pair of apertures/eyelets 22 on opposite sides of a gap. Each pair of apertures/eyelets 22 are configured to receive a fastener (not shown) disposed horizontally therethrough to tighten the clamps 18 onto the lower body portion of the motor 10. Each fastener may include a nut and bolt style arrangement, for example. The C-shaped clamps 18 are of equal diameter and dimension, designed to secure around the lower body portion of the electric motor 10, which has a constant diameter. Generally, the inside diameter of the C-shaped clamps 18 is slightly larger than the outer diameter of the lower body portion of the electric motor 10 prior to installing and tightening the fasteners (not shown). So configured, during installation, the motor 10 can be lowered into the center portion of the metal cage 12 inside of the C-shaped clamps 18, and subsequently the fasteners (not shown) can be tightened to secure (i.e., squeeze) the C-shaped clamps 18 onto the motor 10 to hold the motor 10 in position.

### SUMMARY

One aspect of the present disclosure provides a motor mount spacer/adapter arrangement including a wire cage and at least one spacer/adapter. The wire cage can include one or more clamps having substantially equal inner dimensions. The at least one spacer/adapter disposed adjacent the inner dimension of one of the clamps. The one or more clamps is configured to secure an electric motor in the wire cage. In some versions, the electric motor can have a lower body portion of a first dimension and an upper body portion of a second dimension that is different than the first dimension. Thus, the at least one spacer/adapter can be configured to reside between one of the clamps and one of the upper and lower body portions of the electric motor.

In some aspects, the one or more clamps can include a C-shaped clamp and the inner dimensions comprise inner diameters.

In some aspects, the at least one spacer/adapter can include a C-shaped cuff.

In some aspects, the C-shaped cuff can include one or more upper flanges for engaging an upper end surface of the motor or one of the C-shaped clamps.

In some aspects, the one or more upper flanges can include a return flange for engaging one of the C-shaped clamps such that the one or more upper flanges comprises an upside down U-shaped cross-section.

In some aspects, the at least one spacer/adapter can include one or more vertical spacers configured to be disposed on an upper body portion of the electric motor.

In some aspects, each vertical spacer can include a generally elongated body comprising a spacer plate and a rib configured in a T-shaped cross-section.

In some aspects, each vertical spacer can be disposed in (a) a T-shaped slot formed on the upper body portion of the electric motor or (b) a channel formed between fins on the first body portion of the electric motor.

In some aspects, the arrangement can further include an electric motor disposed in the one or more clamps.

Another aspect of the present disclosure provides a multi-dimension motor mount spacer/adapter arrangement including a wire cage having a first clamp and a second clamp. The first clamp can have a first clamp inner dimension and a first clamp working dimension. The second clamp can have a second clamp inner dimension and a second clamp working dimension. The first clamp working dimension is less than the first clamp inner dimension and the second clamp inner dimension, and the second clamp working dimension is substantially equal to the first clamp inner dimension and the second clamp inner dimension. Thus, the first and second clamps are configured to secure an electric motor in the cage, where the electric motor can have a first body portion of a first dimension substantially equal to the first clamp working dimension and a second body portion of a second dimension that is substantially equal to the second clamp working dimension.

In some aspects, the first clamp can include a spacer/adapter disposed adjacent the first clamp inner dimension, the spacer/adapter defining the first clamp working dimension.

In some aspects, the first clamp can be an upper clamp and the second clamp can be a lower clamp.

In some aspects, each of the first and second clamps can each include a C-shaped clamp and the first and second clamp inner dimensions comprise inner diameters.

In some aspects, the spacer/adapter can include a C-shaped cuff.

In some aspects, the C-shaped cuff can include one or more upper flanges for engaging an upper end surface of the motor or one of the C-shaped clamps.

In some aspects, the one or more upper flanges can include a return flange for engaging one of the C-shaped clamps such that the one or more upper flanges comprises an upside down U-shaped cross-section.

In some aspects, the spacer/adapter can include one or more vertical spacers configured to be disposed on the first body portion of the electric motor.

In some aspects, each vertical spacer can include a generally elongated body having a spacer plate and a rib configured in a T-shaped cross-section.

In some aspects, each vertical spacer can be disposed in (a) a T-shaped slot formed on the first body portion of the electric motor or (b) a channel formed between fins on the first body portion of the electric motor.

In some aspects, the arrangement can further include an electric motor disposed in the first and second clamps.

### BRIEF DESCRIPTION OF THE FIGURES

FIG. 1 is a perspective view of a prior art mount for an electric motor for use with an HVAC unit, for example.

FIG. 2 is a perspective view of a first embodiment of a Multi-Dimension Motor Mount Spacer/Adapter including an electric motor for use with an HVAC unit, for example, and constructed in accordance with the principles of the present disclosure.

FIGS. 3A-3B are perspective views of a second embodiment of a Multi-Dimension Motor Mount Spacer/Adapter including an electric motor for use with an HVAC unit, for example, and constructed in accordance with the principles of the present disclosure.

FIG. 4 is a perspective view of a third embodiment of a Multi-Dimension Motor Mount Spacer/Adapter including an electric motor for use with an HVAC unit, for example, and constructed in accordance with the principles of the present disclosure.

FIGS. 5A-5B are perspective views of components of a fourth embodiment of a Multi-Dimension Motor Mount Spacer/Adapter including an electric motor for use with an HVAC unit, for example, and constructed in accordance with the principles of the present disclosure.

FIGS. 6A-6B are perspective views of components of a fifth embodiment of a Multi-Dimension Motor Mount Spacer/Adapter including an electric motor for use with an HVAC unit, for example, and constructed in accordance with the principles of the present disclosure.

### DETAILED DESCRIPTION OF THE FIGURES

The present disclosure is directed to a multi-dimension motor mount spacer/adapter arrangement for securing electric motors in position. Such an arrangement can be used in, for example, an HVAC unit to secure an electric motor for driving a condenser fan, an evaporator fan, a furnace air handler, etc. Such an arrangement may alternatively be used in any other application within or outside of the HVAC industry where it is desired to reliably secure an electric motor in position for proper alignment with other components including, for example, refrigerators, washing machines, dryers, dishwashers, vacuum cleaners, electric vehicles, etc.

The disclosed multi-dimension motor mount spacer/adapter arrangement is uniquely configured to clamp onto a motor that has two (2) or more different cross-sectional dimensions, e.g., diameters, rather than a constant/uniform cross-sectional dimension, e.g., a uniform cylindrical diameter/dimension. In alternative variations, the disclosed motor mount spacer/adapter arrangement is configured to clamp onto a motor with a single diameter, but which diameter is smaller than a diameter of a clamp for retaining the motor. Moreover, the disclosed multi-diameter motor mount spacer/adapter arrangement is advantageously able to achieve this with minimal (if any) effect on airflow and cooling. The present disclosure includes multiple embodiments, but it is to be understood that these are merely examples, and other embodiments are intended to be within the scope of the disclosure. Moreover, where appropriate, various features of the multiple embodiments may be combined and interchanged such that the disclosed embodiments are not intended to be mutually exclusive embodiments per se.

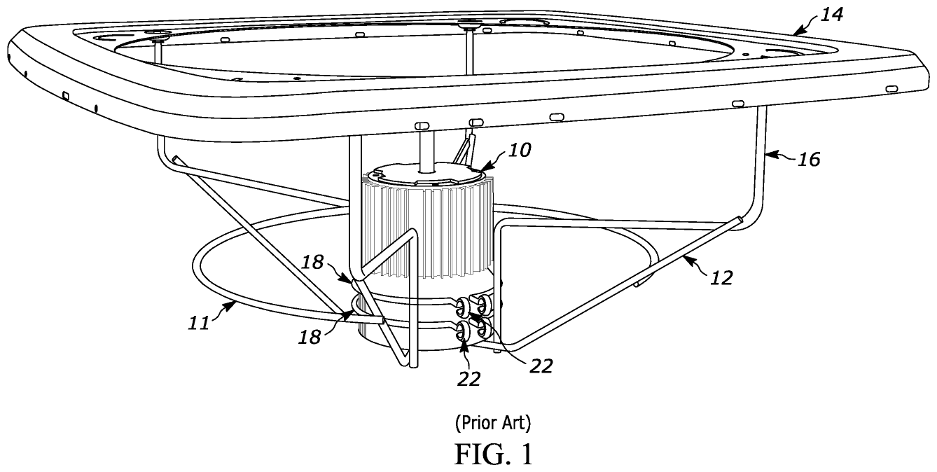

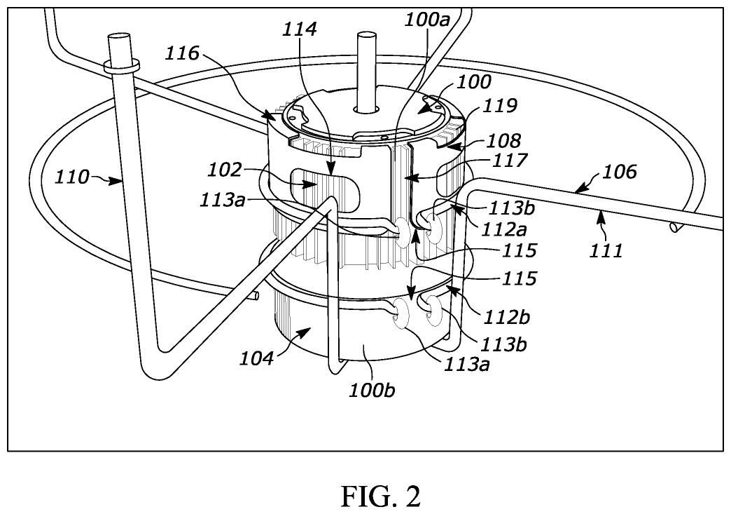

FIG. 2 discloses a first embodiment, where it can be seen that an example of an electric motor 100 includes an upper body portion 102 with fins, and a lower body portion 104 without fins. The upper body portion 102 has an external diameter that is smaller than an external diameter of the lower body portion 104. While the version of the motor 100 in FIG. 2 includes fins on the upper body portion, alternative motors may be designed differently. As further depicted in FIG. 2, a multi-diameter motor mount spacer/adapter arrangement 111 includes (i) a wire cage 106, and (ii) a spacer/adapter 108. The wire cage 106 of FIG. 2 includes four legs 110 for coupling to and extending down from an upper panel of an HVAC unit, for example, which may be similar to the panel 14 illustrated in FIG. 1. In other versions of the present disclosure, the wire cage 106 can have any number of legs, no legs, and/or any other configuration for mounting. As shown, the legs 110 include various contours, bends, etc., and ultimately secure a pair of C-shaped clamps 112 that are shown in FIG. 2 clamped around the electric motor. In FIG. 2, there is an upper C-shaped clamp 112a clamped around the upper body portion 100a of the motor 100, and a lower C-shaped clamp 112b clamped around the lower body portion 100b of the motor 100. Each C-shaped clamp 112 includes a pair of apertures/eyelets 113a, 113b separated by and disposed on opposite sides of a gap 115. Each pair of apertures/eyelets 113a, 113b is configured to receive a fastener (not shown) in a horizontal orientation to tighten the clamps 112 onto the motor 100. Each fastener may include a nut and bolt style arrangement, for example, which when tightened draws the apertures/eyelets 113a, 113b together, thereby closing the gap 115, and compressing (e.g., squeezing) the clamp 112 into the motor 100. The C-shaped clamps 112 in FIG. 2 are of equal diameter, meaning each C-shaped clamp 112a, 112 has the same inner diameter. Generally, the inside diameter of the C-shaped clamps 112 is just slightly larger than outer diameters of the upper body portion 100a and the lower body portion 100b of the motor 100 at least during initial setup for assembly and before the clamps 112 are tightened, as discussed below.

The spacer/adapter 108 in FIG. 2 (and in the embodiments described below) is disposed between the upper C-shaped clamp 112a and the upper body portion 100a of the electric motor 100. So configured, the spacer/adapter 108 compensates for the difference in diameter between the upper body portion 100a and the lower body portion 100b of the electric motor 100 such that the two C-shaped clamps 112 can effectively clamp onto and secure the motor 100 in position. In other variations, it is possible that only one C-shaped clamp 112 is used. The spacer/adapter 108 of FIG. 2 includes a sheet metal component formed in the shape of a hollow C-shaped cuff resembling a partial cylinder. The C-shaped cuff can include (a) a gap 117 generally aligned with the gap 115 in the upper C-shaped clamp 112a, (b) one or more windows 114 (which may also be referred to as openings), and (c) one or more upper flanges 116. The gap 117 in the C-shaped cuff allows for clamping the upper C-shaped clamp 112a and spacer/adapter 108 with the fastener (not shown) onto the upper body portion 100a of the electric motor 100. The one or more windows 114 in the spacer/adapter 108 allow for airflow such that the fins of the electric motor 100 are able to dissipate heat as intended. The one or more upper flanges 116 on the spacer/adapter 108 reside in contact with an upper end surface 119 of the motor 100 to maintain proper positioning of the spacer/adapter 108 relative to the motor 100 and wire cage 106. In FIG. 2, the C-shaped cuff of the spacer/adapter 108 has a vertical height dimension sufficient to extend from the upper end surface 119 of the motor 100 down just below the upper C-shaped clamp 112a. In FIG. 2, the spacer/adapter 108 is not otherwise fixed or connected to the upper C-shaped clamp 112a.

As such, during installation, the motor 100 is lowered into the cage 106 and the spacer/adapter 108 is slid down over the motor 100 until the one or more upper flanges 116 engages the upper end surface 119 of the motor 100. As shown, the spacer/adapter 108 is thus positioned between the upper C-shaped clamp 112a and the upper body portion 100a of the motor 100. This positioning of the spacer/adapter 108 reduces the working diameter (i.e., the diameter of the surface of the arrangement 111 that contacts and engages the motor 100) of the upper C-shaped clamp 112a to effectively meet the outer diameter of the upper body portion 100a of the motor 100. At that point, the C-shaped clamps 112a, 112b can be tightened to compress against the motor 100, thereby securing the motor 100 in position in the cage 106. More specifically, the lower C-shaped clamp 112b can be tightened to directly compress against the lower body portion 100b of the motor 100. Thus, the working diameter of the lower C-shaped clamp 112b is equal to the inner diameter of the lower C-shaped clamp 212b (i.e., the inner diameter and the working diameter are the same). Further, the upper C-shaped clamp 112a can be tightened to compress against the spacer/adapter 108, which in turn compresses against the upper body portion 100a of the motor 100. Again, due to the positioning of the spacer/adapter 108, the working diameter of the upper C-shaped clamp 112a is smaller than the working diameter of the lower C-shaped clamp 112b.

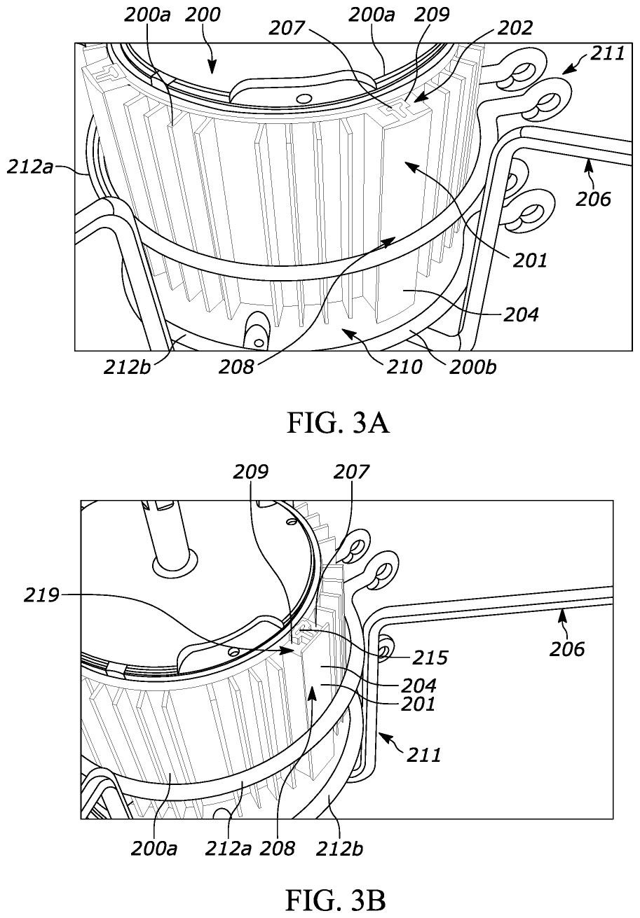

FIGS. 3A and 3B depict a second embodiment of a multi-diameter motor mount spacer/adapter arrangement 211 in accordance with the present disclosure. In FIGS. 3A and 3B, the multi-diameter motor mount spacer/adapter arrangement 211 includes a wire cage 206 and a spacer/adapter 208. The wire cage 206 is generally the same as the cage 106 in FIG. 2 and includes a pair of C-shaped clamps 212a, 212b for securing a motor 200 in the cage 206. But the spacer/adapter 208 is different from the spacer/adapter 108 in FIG. 2. That is, instead of a spacer/adapter 108 that includes a C-shaped cuff, the embodiment of FIGS. 3A and 3B includes a spacer/adapter 208 having one or more vertical spacers 201 that can be slid into T-slots 202 formed on an upper body portion 200a of an electric motor 200. In one embodiment, the system can include 1, 2, 3, 4, or more vertical spacers 201, each including a generally elongated body comprising a spacer plate 204 and a rib 207. As can be seen in FIGS. 3A and 3B, the vertical spacer 201 includes a generally T-shaped cross-section. Furthermore, the rib 207 also has a T-shaped cross-section. As also depicted, the upper body portion 200a of the electric motor 200 can include 1, 2, 3, 4, or more vertical grooves 209, each having a T-shaped cross-section sized and configured for receiving a rib 207 of one of the one or more vertical spacers 201. So configured, as shown, when the vertical spacers 201 are slid into the grooves 209, the elongated spacer plates 204 are disposed on the outside of the upper body portion 200a of the electric motor 200, thereby increasing the effective diameter of the upper body portion 200a.

During installation, the motor 200 is lowered into the cage 206, inside of the C-shaped clamps 212a, 212b, and the one or more vertical spacers 201 are slid down into the corresponding vertical grooves 209 in the electric motor 200. As shown, the spacer/adapter 208 is thus positioned between the upper C-shaped clamp 212a and the upper body portion 200a of the motor 200. This positioning of the spacer/adapter 208 reduces the working diameter (i.e., the diameter of the surface of the arrangement 211 that contacts and engages the motor 200) of the upper C-shaped clamp 212a to effectively meet the outer diameter of the upper body portion 200a of the motor 200. At that point, the C-shaped clamps 212a, 212b can be tightened to compress against the motor 200, thereby securing the motor 200 in position in the cage 206. More specifically, the lower C-shaped clamp 212b can be tightened to directly compress against the lower body portion 200b of the motor 200. Thus, the working diameter of the lower C-shaped clamp 212b is equal to the inner diameter of the lower C-shaped clamp 212b (i.e., the inner diameter and the working diameter are the same). Further, the upper C-shaped clamp 212a can be tightened to compress against the spacer/adapter 208, which in turn compresses against the upper body portion 200a of the motor 200. Again, due to the positioning of the spacer/adapter 208, the working diameter of the upper C-shaped clamp 212a is smaller than the working diameter of the lower C-shaped clamp 212b.

Other assembly methods are contemplated including, for example, placing the vertical spacers 201 in the grooves 209 prior to lowering the motor 200 into the cage 206. In some versions, the vertical spacers 201 are slid down until bottom ends thereof come into contact with a shoulder portion 210 (seen in FIG. 3A) of the electric motor 200, where the shoulder portion 210 represents a transition for the increase in diameter between a narrower upper body portion 200a and a wider lower body portion 200b of the electric motor 200. In other versions, as depicted in FIG. 3B, an upper end 201a of each vertical spacer 201 can include an upset 215, which contacts an upper end surface 219 of the motor 200 thereby acting as a positive stop to prevent further sliding of the spacer 201 down. Either way, once the one or more vertical spacers 201 is in position, the C-shaped clamps 212a, 212b can be tightened to secure the motor 200 in position.

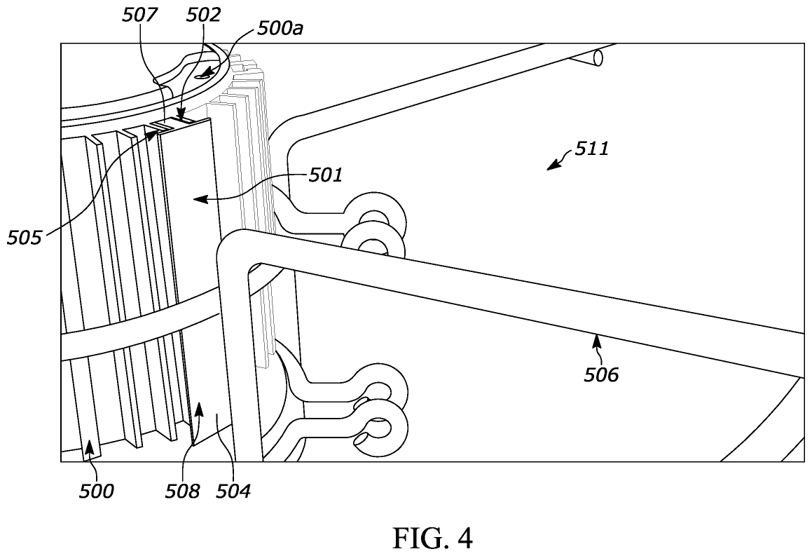

FIG. 4 depicts a third embodiment of a multi-diameter motor mount spacer/adapter arrangement 511 constructed in accordance with the principles of the present disclosure. In FIG. 4, the multi-diameter motor mount spacer/adapter arrangement 511 includes a wire cage 506 having upper and lower C-shaped clamps 512a, 512b and a spacer/adapter 508. The wire cage 506 is the same as the wire cages in FIGS. 2, 3A, and 3B. Additionally, similar to FIGS. 3A and 3B, the multi-diameter motor mount spacer/adapter arrangement 511 in FIG. 4 includes one or more vertical spacers 501. But instead of using a spacer/adapter that includes one or more vertical spacers 200 disposed in T-slots 202 on the upper body portion of the electrical motor, as in FIGS. 3A and 3B, the embodiment of FIG. 4 features a spacer/adapter 511 that includes one or more vertical spacers 501 disposed in a conventional channel 502 formed between a pair of opposing fins 505 on an upper body portion 500a of the electric motor 500. In one embodiment, the system of FIG. 4 can include 1, 2, 3, 4, or more vertical spacers 501, each including a generally elongated body having a T-shaped cross-section comprising a spacer plate 504 and a rib 507. And by way of the conventionally formed cooling fins 505, the upper body portion 500a of the electric motor 500 can include 2, 3, 4, or more vertical channels 502 for receiving the rib(s) 507. So configured, as shown, when the vertical spacers 501 are disposed in the channel(s) 508, the elongated spacer plates 504 are disposed on the outside of the upper body portion 500a of the electric motor 500, thereby increasing the effective diameter of the upper body portion 500a.

During installation, the motor 500 is lowered into the cage 506 and the vertical spacers 501 can be slid down into the corresponding vertical channels 502 between the fins 505 of the electric motor 500. As shown, the spacer/adapter 508 is thus positioned between the upper C-shaped clamp 512a and the upper body portion 500a of the motor 500. This positioning of the spacer/adapter 508 reduces the working diameter (i.e., the diameter of the surface of the arrangement 511 that contacts and engages the motor 500) of the upper C-shaped clamp 512a to effectively meet the outer diameter of the upper body portion 500a of the motor 500. At that point, the C-shaped clamps 512a, 512b can be tightened to compress against the motor 500, thereby securing the motor 500 in position in the cage 506. More specifically, the lower C-shaped clamp 512b can be tightened to directly compress against the lower body portion 500b of the motor 500. Thus, the working diameter of the lower C-shaped clamp 512b is equal to the inner diameter of the lower C-shaped clamp 512b (i.e., the inner diameter and the working diameter are the same). Further, the upper C-shaped clamp 512a can be tightened to compress against the spacer/adapter 508, which in turn compresses against the upper body portion 500a of the motor 500. Again, due to the positioning of the spacer/adapter 508, the working diameter of the upper C-shaped clamp 512a is smaller than the working diameter of the lower C-shaped clamp 512b.

Other assembly methods are contemplated including, for example, placing the vertical spacers 501 in the channels 502 prior to lowering the motor 500 into the cage 506. In some versions, the vertical spacers 501 are slid down until bottom ends thereof come into contact with a shoulder portion of the electric motor 500, similar to that described with reference to FIG. 3A above. In other versions, upper ends of the vertical spacers 501 include upsets or some other physical feature, which contacts the upper end surface of the motor 500 acting as a positive stop to prevent further sliding of the spacers 501 down similar to that described above with reference to FIG. 3B. Either way, once the vertical spacers 501 are in position, the C-shaped clamps 512a, 512b can be tightened to secure the motor in position.

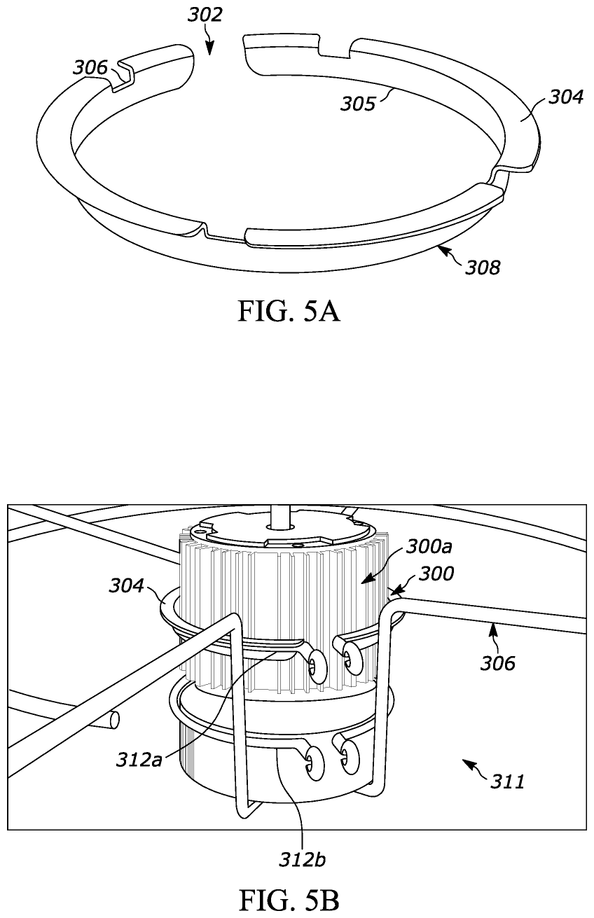

FIGS. 5A and 5B depict a fourth embodiment of the disclosed multi-diameter motor mount spacer/adapter arrangement 311 constructed in accordance with the principles of the present disclosure. In FIGS. 5A and 5B, the multi-diameter motor mount spacer/adapter arrangement 311 includes a wire cage 306 having upper and lower C-shaped clamps 312a, 312b and a spacer/adapter 308. The wire cage 308 is the same as the wire cages in FIG. 2, FIGS. 3A and 3B, and FIG. 4. The spacer/adapter 308 in FIGS. 5A and 5B includes a sheet metal C-shaped cuff that is disposed between the upper C-shaped clamp 312a of the wire cage 306 and an upper body portion 300a of the electric motor 300. Unlike the spacer/adapter 108 of FIG. 2, the spacer/adapter 308 of FIGS. 5A and 5B has a much smaller vertical dimension and no windows. The spacer/adapter 308 of FIGS. 5A and 5B includes a gap 302 to allow flexing of the material upon tightening like FIG. 2, and one or more upper flanges 304. As can be seen in FIG. 5A, for example, the spacer/adapter 308 generally includes an inner wall 305 in the form of a partial cylindrical shape, and the upper flanges 304 extend radially outwardly from the inner wall 305. In this configuration, the upper flanges 304 all reside in a common horizontal plane that is approximately perpendicular to a cylindrical plane occupied by the inner wall 305. So configured, when the spacer/adapter 308 is installed, the upper flanges 304 reside above and in contact with the upper C-shaped clamp 312a of the wire cage 306 to properly position the spacer/adapter 308 relative to the cage 306 and motor 300. More specifically, by engaging the upper C-shaped clamp 312a, the upper flanges 304 ensure that the inner wall 305 of the spacer/adapter 308 is disposed directly between the upper C-shaped clamp 312a and the upper body portion 300a of the motor 300. The spacer/adapter 308 also includes, in the depicted version, four (4) recesses 306 for receiving the four (4) legs of the wire cage 306. This advantageously ensures that the gap 302 in the spacer/adapter 308 is properly aligned with a corresponding gap between the opposite terminal ends of the upper C-shaped clamp 312a, thereby ensuring that tightening of the upper C-shaped clamp 312a tightens the spacer/adapter 308 a corresponding amount. Of course, other designs are possible to accommodate wire cages of different designs.

During installation, the motor 300 is lowered into the cage and the spacer/adapter 308 is slid down over the electric motor 300 until the one or more upper flanges 304 contacts the upper C-shaped clamp 312a acting as a positive stop. As shown, the spacer/adapter 308 is thus positioned between the upper C-shaped clamp 312a and the upper body portion 300a of the motor 300. This positioning of the spacer/adapter 308 reduces the working diameter (i.e., the diameter of the surface of the arrangement 311 that contacts and engages the motor 300) of the upper C-shaped clamp 312a to effectively meet the outer diameter of the upper body portion 300a of the motor 300. At that point, the C-shaped clamps 312a, 312b can be tightened to compress against the motor 300, thereby securing the motor 300 in position in the cage 306. More specifically, the lower C-shaped clamp 312b can be tightened to directly compress against the lower body portion 300b of the motor 300. Thus, the working diameter of the lower C-shaped clamp 312b is equal to the inner diameter of the lower C-shaped clamp 312b (i.e., the inner diameter and the working diameter are the same). Further, the upper C-shaped clamp 312a can be tightened to compress against the spacer/adapter 308, which in turn compresses against the upper body portion 300a of the motor 300. Again, due to the positioning of the spacer/adapter 308, the working diameter of the upper C-shaped clamp 312a is smaller than the working diameter of the lower C-shaped clamp 312b.

Other assembly methods are contemplated including, for example, placing the spacer/adapter 308 into the cage 306 prior to lowering the motor 300 into the cage 306. At this point, the C-shaped clamps 312a, 312b can be tightened to secure the motor 300 in position.

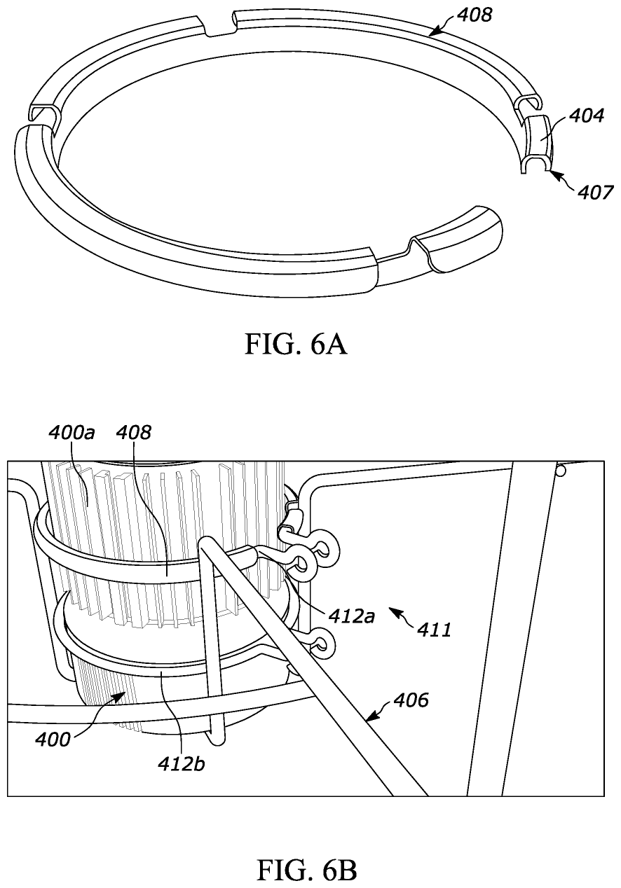

FIGS. 6A and 6B depict a fifth embodiment of a multi-diameter motor mount spacer/adapter arrangement 411 constructed in accordance with the principles of the present disclosure. In FIGS. 6A and 6B, the multi-diameter motor mount spacer/adapter arrangement 411 includes a wire cage 406 having upper and lower C-shaped clamps 412a, 412b and a spacer/adapter 408. The wire cage 406 is the same as the wire cages in FIG. 2, FIGS. 3A and 3B, and FIG. 4. In FIGS. 6A and 6B, all aspects are the same as in FIGS. 5A and 5B, but for the upper flanges 404 on the spacer/adapter 408, i.e., C-shaped cuff. That is, in FIGS. 6A and 6B, the upper flanges 404 include an extra return flange 407 that turns downward to reside around and outside of the C-shaped upper clamp 412a. As such, the spacer/adapter 408 in FIGS. 6A and 6B has a generally upside down U-shaped cross-section, as can be seen in FIG. 6A, for example. In some forms, the upper flanges 404 can be described as including a radially extending portion 404a and an axially extending portion 404b, the axially extending portion 404b corresponding to the above-described return flange 407. In some versions, the radially extending portions 404a extend in a common horizontal plane and are generally flat. But in other versions, the radially extending versions 404a could be convexly curved upward such that a lower surface thereof is concave to fit tightly to the rounded profile of the wire that forms the upper C-shaped clamp 412a. Regardless of the specific construct, the spacer/adapter 408 with return flange 407 can provide extra security in the positioning of the spacer/adapter 408 relative to the cage 406 and motor 400 during installation.

During installation, the motor 400 is lowered into the cage and the spacer/adapter 408 is slid down over the electric motor 400 until the one or more upper flanges 404 contacts the upper C-shaped clamp 412a acting as a positive stop. As shown, the spacer/adapter 408 is thus positioned between the upper C-shaped clamp 412a and the upper body portion 400a of the motor 400. This positioning of the spacer/adapter 408 reduces the working diameter (i.e., the diameter of the surface of the arrangement 411 that contacts and engages the motor 400) of the upper C-shaped clamp 412a to effectively meet the outer diameter of the upper body portion 400a of the motor 400. At that point, the C-shaped clamps 412a, 412b can be tightened to compress against the motor 400, thereby securing the motor 400 in position in the cage 406. More specifically, the lower C-shaped clamp 412b can be tightened to directly compress against the lower body portion 400b of the motor 400. Thus, the working diameter of the lower C-shaped clamp 412b is equal to the inner diameter of the lower C-shaped clamp 412b (i.e., the inner diameter and the working diameter are the same). Further, the upper C-shaped clamp 412a can be tightened to compress against the spacer/adapter 408, which in turn compresses against the upper body portion 400a of the motor 400. Again, due to the positioning of the spacer/adapter 408, the working diameter of the upper C-shaped clamp 412a is smaller than the working diameter of the lower C-shaped clamp 412b.

Other assembly methods are contemplated including, for example, placing the spacer/adapter 408 into the cage 406 prior to lowering the motor 400 into the cage 406. At this point, the C-shaped clamps 412a, 412b can be tightened to secure the motor 400 in position.

Based on the foregoing, it can be seen that the present disclosure advantageously provides various embodiments of a multi-diameter motor mount spacer/adapter arrangement that ultimately includes two C-shaped clamps of the same inner diameter. But due to the incorporation of the spacer/adaptor, one of those clamps (e.g., the upper C-shaped clamps in the embodiments described above) ultimately possesses an inner working diameter that is less than the inner diameter of the C-shaped clamp. The other C-shaped clamp (e.g., the lower C-shaped clamps in the embodiments described above) is not equipped with a spacer/adapter and, thus, it's inner working diameter is equal to the inner diameter of the upper and lower C-shaped clamps. So configured, the disclosed arrangements can effectively clamp onto motors having different upper and lower diameters, as disclosed hereinabove. The disclosure however is not limited to configurations aimed to clamping to motors only having two different dimensions. In fact, the present disclosure can be adopted to accommodate motors with 3, 4, or more different diameters by configuring a multi-diameter motor mount spacer/adapter arrangement with the corresponding number of C-shaped clamps, for example, one or more of each can be equipped with a spacer/adaptor of the appropriate thickness to achieve the intended clamping force.

While each of the embodiments described above are disclosed for clamping a motor with two distinct diameters, the present disclosure also includes variations for clamping electric motors with one (1) diameter, or three (3) or more different diameter portions. In such versions, the same two-diameter clamping arrangements may be used or even clamping arrangement including three or more different clamping points. For example, in a version with a three-diameter motor, there could be spacers/adapters with different thicknesses to achieve the intended objective.

Furthermore, while the electric motor of the present disclosure has thus far been depicted as generally cylindrical in shape, thereby having a circular cross-section with one or more diameters, the present disclosure can also apply to electric motors having different shapes including cross-sections, for example, which could be square, pentagonal, hexagonal, octagonal, oval, rectangle, or any other possible shape. In particular, with these alternative shapes, the system of the invention could include one or more vertical spacers similar to those disclosed in FIGS. 3A, 3B and 4. To compensate for the difference between the dimensional shape of the C-shaped clamps and the dimensional shape of the non-circular motor, the vertical spacers could have thicker spacer plates 204, 504 and/or longer ribs 207, 507, as needed. Similarly, with the embodiments of FIGS. 2, 5A, 5B, 6A, and 6B, the C-shaped cuffs could be modified with thicker sections to compensate for the difference between the dimensional shape of the C-shaped clamps and the dimensional shape of the non-circular motor. That is, the C-shaped cuffs could be designed to include an outer surface that possesses a cylindrical shape complimentary to the inner surface of C-shaped clamp and an inner surface shaped to correspond to whatever shape and geometry is present on the exterior of the electric motor. While the aforementioned alternatives reference C-shaped clamps, in other variations, the clamps themselves may not be C-shaped but rather a particular shape to correspond to the external geometry of the electric motor when the electric motor is not cylindrical. For example, if the electric motor has a square cross-section, the clamps can be square. All other features would remain the same.

Based on the foregoing, it can be appreciated that the embodiments of FIG. 2, FIGS. 5A and 5B, and FIGS. 6A and 6B include arrangements where upper and lower C-shaped clamps apply clamping forces around the entirety of the electric motor. Alternatively, the embodiments of FIGS. 3A and 3B and FIG. 4 include arrangements where one of the upper and lower C-shaped clamps applies a clamping force at multiple discrete points about the circumference of the electric motor. Specifically, in FIGS. 3A, 3B, and 4, the upper C-shaped clamp applies clamping force at discrete points defined by the locations of the one or more vertical spacers. In all embodiments, one advantage is that the clamping force applied by the upper C-shaped clamp is distributed around the finned upper body portion of the electric motor, which advantageously avoids yielding or damaging the fin section. This can be particularly advantageous when the fins are constructed of materials prone to yielding such as, for example, aluminum.

It should be appreciated that the various embodiments of the spacer/adapter disclosed herein can be constructed of any material including, for example, aluminum, plastic, rubber, steel, etc. One advantage of aluminum may be that it won't degrade/creep over time when exposed to harsh, outdoor conditions.

It should further be appreciated that any of the spacer/adapter embodiments disclosed would be inserted into the proper location/position and then the motor mount can be tightened. This can provide a more robust clamping position when compared to prior designs, as well as align the motor properly due to being able to clamp the same diameter as well as spread the clamps farther apart resulting in a more secure grip.

What is claimed:

1. A motor mount spacer/adapter arrangement, comprising:
a wire cage including one or more clamps having substantially equal inner dimensions, and
at least one spacer/adapter disposed adjacent the inner dimension of one of the clamps,
wherein the one or more clamps is configured to secure an electric motor in the wire cage, the electric motor having a lower body portion of a first dimension and an upper body portion of a second dimension that is different than the first dimension, the at least one spacer/adapter configured to reside between one of the clamps and one of the upper and lower body portions of the electric motor.

2. The arrangement of claim 1, wherein each of the one or more clamps comprises a C-shaped clamp and the inner dimensions comprise inner diameters.

3. The arrangement of claim 1, wherein the at least one spacer/adapter comprises a C-shaped cuff.

4. The arrangement of claim 3, wherein the C-shaped cuff comprises one or more upper flanges for engaging an upper end surface of the motor or one of the C-shaped clamps.

5. The arrangement of claim 4, wherein the one or more upper flanges comprises a return flange for engaging one of the C-shaped clamps such that the one or more upper flanges comprises an upside down U-shaped cross-section.

6. The arrangement of claim 1, wherein the at least one spacer/adapter comprises one or more vertical spacers configured to be disposed on an upper body portion of the electric motor.

7. The arrangement of claim 6, wherein each vertical spacer comprises a generally elongated body comprising a spacer plate and a rib configured in a T-shaped cross-section.

8. The arrangement of claim 6, wherein each vertical spacer is disposed in (a) a T-shaped slot formed on the upper body portion of the electric motor or (b) a channel formed between fins on the first body portion of the electric motor.

9. The arrangement of claim 1, further comprising an electric motor disposed in the one or more clamps.

10. A multi-dimension motor mount spacer/adapter arrangement, comprising:
a wire cage including:
a first clamp having a first clamp inner dimension and a first clamp working dimension, and
a second clamp having a second clamp inner dimension and a second clamp working dimension,
the first clamp working dimension being less than the first clamp inner dimension and the second clamp inner dimension,
the second clamp working dimension substantially equal to the first clamp inner dimension and the second clamp inner dimension,
wherein the first and second clamps are configured to secure an electric motor in the cage, the electric motor having a first body portion of a first dimension substantially equal to the first clamp working dimension and a second body portion of a second dimension that is substantially equal to the second clamp working dimension.

11. The arrangement of claim 10, wherein the first clamp includes a spacer/adapter disposed adjacent the first clamp inner dimension, the spacer/adapter defining the first clamp working dimension.

12. The arrangement of claim 10, wherein the first clamp is an upper clamp and the second clamp is a lower clamp.

13. The arrangement of claim 10, wherein each of the first and second clamps each comprises a C-shaped clamp and the first and second clamp inner dimensions comprise inner diameters.

14. The arrangement of claim 11, wherein the spacer/adapter comprises a C-shaped cuff.

15. The arrangement of claim 14, wherein the C-shaped cuff comprises one or more upper flanges for engaging an upper end surface of the motor or one of the C-shaped clamps.

16. The arrangement of claim 15, wherein the one or more upper flanges comprises a return flange for engaging one of the C-shaped clamps such that the one or more upper flanges comprises an upside down U-shaped cross-section.

17. The arrangement of claim 11, wherein the spacer/adapter comprises one or more vertical spacers configured to be disposed on the first body portion of the electric motor.

18. The arrangement of claim 17, wherein each vertical spacer comprises a generally elongated body comprising a spacer plate and a rib configured in a T-shaped cross-section.

19. The arrangement of claim 17, wherein each vertical spacer is disposed in (a) a T-shaped slot formed on the first body portion of the electric motor or (b) a channel formed between fins on the first body portion of the electric motor.

20. The arrangement of claim 10, further comprising an electric motor disposed in the first and second clamps.
